(19) United States
(12) Patent Application Publication
(10) Pub. No.: US 2002/0161982 A1
(43) Pub. Date: Oct. 31, 2002

(54) System and method for implementing a storage area network system protocol

(76) Inventor: Erik Riedel, San Francisco, CA (US)

Correspondence Address: HEWLETT-PACKARD COMPANY, Intellectual Property Administration, P.O. Box 272400, Fort Collins, CO, 80527-2400, US

(21) Appl. No.: 09/843,881

(22) Filed: Apr. 30, 2001

(51) Int. Cl. G06F 13/00

(52) U.S. Cl. 711/170

(57) ABSTRACT

A system and method for improving communication between a storage area network (“SAN”) and a network attached storage (“NAS”). The NAS, implementing a file system, may be configured to create a message to inform an underlying SAN utilizing a list of freed blocks in response to a file and/or directory deletion by a client. The NAS outputs the freed block message to the SAN. The SAN may be configured to maintain a current free block table (or current free block list). The SAN may be further configured to update the current free block table in response to receiving the freed block message from the NAS. As a result, any block listed on the current free block table may be flushed from the SAN, marked as unused by the data storage system or may be marked as allocated but unused. If the SAN marks blocks as unused, the unused blocks are eligible for migration to relatively less expensive storage within the SAN. The sending of the freed block messages from the NAS to the SAN can be done in an “out of band” fashion, without changing the native interface between the NAS and the SAN. These messages do not affect the correctness of the data sent from the SAN to the NAS, only the performance of the responses from the SAN to the NAS.

### FIELD OF THE INVENTION

This invention relates generally to storage systems. In particular, the present invention pertains to storage system protocols.

### DESCRIPTION OF THE RELATED ART

A traditional client-server environment typically includes clients interfaced with servers over a network. The clients, often located remotely from the servers, are typically implemented with workstations, terminals, and the like. The servers typically provide applications, data, input/output services, etc., to the clients.

The servers typically provide data storage services by utilizing data storage devices attached to the servers. The data storage devices are typically individual disk drives, arrays of disk drives, tape storage, etc. However, the proliferation of data intensive applications, e.g., data warehousing, data mining, on-line transactions, multimedia Internet, and intranet browsing, has rapidly strained the traditional client-server data storage capacity. Moreover, the use of automated backup systems for the data storage devices has reduced the available server bandwidth.

One solution to the data requirements of data intensive applications is a combination of a network attached storage (“NAS”) system and a storage area network (“SAN”) system. A NAS is typically a special purpose server with its own internet protocol (“IP”) address that provides the capability to clients and application servers access to storage. An example of a conventional NAS is described in U.S. Pat. No. 5,802,366 to Roe et al, which is hereby incorporated in its entirety by reference. In particular, the NAS is specifically designed for file sharing. Clients and/or application servers may communicate with a NAS using a number of network protocols such as NETWORK FILE SYSTEM (“NFS”), COMMON INTERNET FILE SYSTEM (“CIFS”), TRANSFER CONTROL PROTOCOL/INTERNET PROTOCOL (“TCP/IP”), hypertext transfer protocol, etc., over existing network infrastructure such as fiber distributed data interface (“FDDI”), Ethernet topologies, and the like.

The SAN is generally storage devices, e.g., individual disk drives, arrays of disk drives, tape storage device, etc., interfaced with data servers over a shared high-speed network. The data servers provide an interface between the interconnected storage devices, clients and/or application servers. The SAN system typically uses an encapsulated small computer system interface (“SCSi”) protocol to communicate among the storage devices.

Within the NAS-SAN combination system, the NAS, acting like a file sharing system, typically communicates with the SAN using a block level disk protocol such as SCSI. When clients and/or application servers issue commands, e.g., read, write, and delete, the NAS translates the issued commands into SCSI commands for the SAN. As a result, the NAS is aware of which files are relevant to the clients and/or application servers. Moreover, the NAS is aware of the corresponding blocks in the storage devices of the SAN that define the location of the relevant files. From the SAN perspective, the SAN is receiving commands to write to certain block address and/or retrieve specified block addresses according to the SCSI protocol.

However, the SAN is not merely a disk storage device for the NAS. The SAN is typically an “intelligent” storage system configured to optimize data access. In particular, the storage devices of a SAN may be arranged in a hierarchical disk array storage system as described by U.S. Pat. No. 5,664,187 to Burkes et al, which is hereby incorporated in its entirety. A controller in the SAN may be configured to map the physical storage space of the storage devices into two virtual storage spaces. The first virtual storage space is configured to present the physical storage into two redundant array of independent disk (“RAID”) areas: a mirror (RAID level 1) area and a parity (RAID level 5) area, thereby creating a multi-tiered storage system. The second virtual storage space, an application-level storage space, is configured to present to clients/application servers the physical storage of the storage devices as multiple virtual blocks, where a virtual block may be associated with the mirror RAID area or the virtual RAID area.

The mirror area may be viewed as “expensive” storage for the virtual blocks and the parity area may be viewed as “in expensive” storage for the virtual blocks.

Typically, the performance of the parity RAID area, i.e., speed of data access, is lower than the mirror RAID area. As a result, the controller of the SAN may be further configured to migrate the virtual blocks between the mirror RAID area and the virtual RAID area to optimize performance and reliability of the SAN.

Although the NAS-SAN combination may solve a variety of data-intensive problems, the NAS-SAN combination still has some drawbacks. For instance, the nature of a block level disk protocol such as SCSI requires a storage device to read and/or write to specified block addresses. Thus, the SAN may not be aware of which blocks in the storage devices are in use at any particular time by the NAS. As a result, a SAN may initiate tasks such as caching, migrating data, etc., on blocks of data that have been de-allocated by the NAS.

Moreover, the SAN typically cannot optimize blocks in its storage device for improved performance. The NAS of the NAS-SAN combination system typically maintains a list of free blocks for allocation during file operations. However, the SAN has no indication of which blocks, in the storage devices of the SAN, are to be allocated next. As a result, the SAN is not aware of which blocks are to be used by the NAS until the command is received. Accordingly, the SAN cannot anticipate the next blocks to be allocated by the NAS, thus reducing the efficiency of data access.

### SUMMARY OF THE INVENTION

According to one aspect, the present invention relates to a method for optimizing a storage system. The method includes receiving an optimization information not included in a disk protocol of the storage systemoptimizing the storage system according to the optimization information.

In another aspect, the present invention relates to a computer readable storage medium on which is embedded one or more computer programs. The one or more computer programs implements a method of optimizing a storage system. The one or more computer programs includes a set of instructions for receiving an optimization information not included in a disk protocol of the storage system and optimizing the storage system according to the optimization information.

In another aspect, the present invention relates to a system for optimizing storage. The system includes a file system controller and a storage system. The file system controller is configured to generate an optimization information, where the optimization information is transmitted to the storage system and is not included in a disk protocol of said disk storage system.

### BRIEF DESCRIPTION OF THE DRAWINGS

Features and advantages of the present invention will become apparent to those skilled in the art from the following description with reference to the drawings, in which:

FIG. 1 illustrates a system for implementing an exemplary embodiment of the present invention;

FIG. 2 illustrates a detailed block diagram of a system implementing an exemplary embodiment of the present invention;

FIG. 3 illustrates an exemplary block diagram of the NAS shown in FIG. 2 in accordance with the principles of the present invention;

FIG. 4 illustrates an exemplary detailed block diagram of the SAN shown in FIG. 2 in accordance with the principles of the present invention;

FIG. 5 illustrates an exemplary flow diagram of a generation of a freed block message in the NAS shown in FIGS. 2 and 3; and

FIG. 6 illustrates an exemplary flow diagram of processing a freed block message in the SAN shown in FIGS. 2 an

### DETAILED DESCRIPTION OF THE INVENTION

For simplicity and illustrative purposes, the principles of the present invention are described by referring mainly to an exemplary embodiment thereof, particularly with references to a freed block message in which a data storage system may optimize its performance, reliability, etc., in response to receiving of the freed block message. However, one of ordinary skill in the art would readily recognize that the same principles are equally applicable to, and can be implemented in, any device that may benefit from receiving optimization information, and that any such variation would be within such modifications that do not depart from the true spirit and scope of the present invention. Moreover, in the following detailed description, references are made to the accompanying drawings, which illustrate specific embodiments in which the present invention may be practiced. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with the principles of the present invention, a protocol for transferring optimization information is implemented to optimize performance in a data storage system. In particular, a host device may be configured to communicate with a data storage system utilizing a disk protocol such as SCSI, Advanced Technology Attachment (“ATA”), etc. The host device may be further configured to transmit optimization information outside of the normal disk protocol used between the host device and the data storage system. In effect, the optimization information may be viewed as “out-of-band” information. The optimization information may then be used by the data storage system to optimize the performance and reliability of the data storage system. For example the optimization information may include a list of freed blocks transmitted from the host device to the disk storage system.

In one aspect of the present invention, the data storage system may be configured receive optimization information in addition to utilizing a conventional disk protocol such as SCSI, ATA, etc. The optimization information may then be used to optimize, e.g., migrating blocks, caching blocks, etc., the storage devices of the data storage system. Also, the performance of the data storage system may be improved by removing the designated blocks from a cache (freeing resources) in the data storage system and/or by potentially migrating the designated blocks to less expensive storage.

In another aspect of the present invention, the host device may be further configured to maintain an ordered list in a pool of free blocks. The host device may then utilize the blocks in order based on the ordered list for file management. The data storage system may be configured to maintain a complementary ordered list of free blocks. As a result, the disk storage system may maintain the blocks near the top of the ordered list in a cache, thereby optimizing data access for the host device. Furthermore, the disk storage system may make eligible for migration the blocks at the end of the ordered list to further optimize data access.

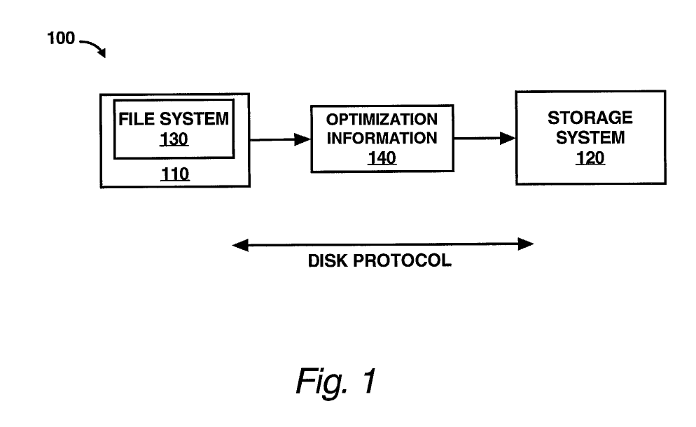

FIG. 1 illustrates a system 100 for implementing an exemplary embodiment of the present invention. The system 100 includes a host device 110 and a data storage system 120. The host device 110 may be configured to implement a network file system 130 such as NFS, Common Internet File System (“CIFS”), etc. The host device 110 may be implemented as a personal computer, a workstation, a server, a NAS and the like.

The data storage system 120 may be configured to provide storage services to the host device 110. Disk drives, an array of disk drives, a SAN and the like may be configured to implement the data storage system 120. The data storage system 120 may be further configured as a multi-tiered storage system, where data may be stored in a plurality of different storage areas. Each storage area may be differentiated based on performance factors such as throughput, disk input/output, costs, redundancies, etc. Moreover, the data storage system 120 may be further configured to migrate data within each storage area to optimize aspects of performance such as throughput, costs, disk access, etc.

The host device 110 and the data storage system 120 may be configured to communicate with each other utilizing a disk protocol such as SCSI over a dedicated high-speed channel such as FIBRE CHANNEL, IEEE1394 and the like.

The host device 110 may be configured to transmit optimization information 140 to the data storage system 120 outside of the normal disk protocol in response to a event in the host device such as a file deletion, creation, and the like. The optimization information may then be used by a controller (not shown) of the data storage system 120 to optimize the storage devices of the data storage system 120 for performance, reliability, etc. The optimization information 140, for example, may include blocks freed by a file and/or directory deletion. The data storage system 120 may maintain a listing of currently free blocks, which may be updated by the optimization information 140. As a result of the updating, the data storage system 120 may be further configured to flush blocks listed in the listing of currently free blocks from the data storage system, mark as unused any blocks listed in the listing of currently free blocks or mark as allocated but unused any blocks listed in the listing of currently free blocks.

In another aspect of the present invention, the host device 110 may be configured to maintain an ordered available free block table. The ordering of the available free block table may be done according to physical location of the blocks in the data storage system 120 or other user- or system-specified criteria. In a preferred embodiment, the host device 110 may be configured to utilize the blocks in order from the ordered current free block table. Also, the disk storage system 120 may be configured to maintain a complementary ordered list of free blocks. As a result, the disk storage system 120 may maintain the blocks near the top of the ordered list in a cache in order to optimize data access for the host device. Furthermore, the disk storage system 120 may make eligible for migration the blocks at the end of the ordered list to further optimize data access.

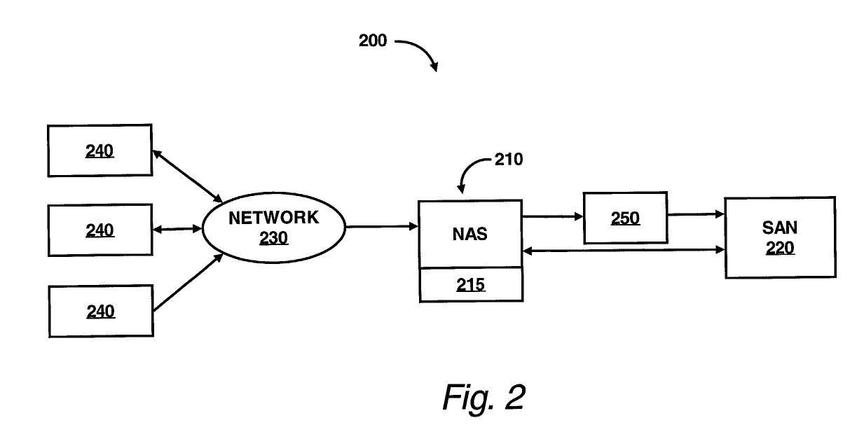

FIG. 2 illustrates a detailed block diagram of a system 200 implementing an exemplary embodiment of the present invention. In particular, the system 200 includes a NAS 210 and a SAN 220. The NAS 210 may be configured to provide access to data storage capabilities of the SAN 220 through a network 230. The network 230 may be configured to provide a communication channel between the NAS 210 and clients 240. The clients 240 may be implemented as personal computers, workstations, servers, and the like.

The NAS 210 may be further configured to provide a network file system 215 for the clients 240. The network file system 215 may be implemented using NFS, CIFS or the like. The clients 240 may create, access, and/or delete files by executing the appropriate commands, which are then transmitted, via the network 230, to the NAS 210. The NAS 210 and the SAN 220 may communicate with each other using a disk protocol such as SCSI over a high-speed dedicated communication channel such as FIBRE channel, IEEE1394 and the like.

The SAN 220 may be configured as a multi-tiered hierarchal storage system as described by U.S. Pat. No. 5,664,187. The SAN 220 may be implemented with a plurality of storage devices such as disk drives, tape drive, etc. The physical storage may be represented as two virtual storage spaces. The first virtual storage space is configured to represent the physical storage as a mirror (RAID level 1) area and a parity (RAID level 5) area thus creating the multi-tiered storage system. The second virtual storage space, an application-level storage space, is configured to present to clients/application servers the physical storage of the storage devices as multiple blocks, where a block may be associated with either the mirror RAID area or the virtual RAID area.

In one aspect of the present invention, a NAS 220 may send an optimization information 250 to the SAN 220. Subsequently, the optimization information may be utilized by the SAN 220 to optimize the blocks in the storage devices for performance reliability, etc. For example, a client 240 may execute a remove (or delete) command on a file (or directory) maintained by the network file system 215 on the NAS 210. The NAS 210 may be configured to delete the file and update an available free block table with the freed blocks associated with the deleted file (or directory). The NAS 210 may be further configured to generate and transmit a freed block message, as an example of optimization information 250, listing the freed blocks from the deleted file to the SAN 220. As a result, the SAN 220 may be configured to update a current free block table with the freed blocks in response to receiving the freed block message. Subsequently, the SAN 220 may flush from the SAN 220, mark as unused by the SAN 220 or mark as allocated but unused any blocks listed in the current free block table. The sending of the optimization information, e.g., the freed block message, from the NAS to the SAN can be done in an “out of band” manner, without changing the native interface between the NAS and the SAN. The optimization information do not affect the correctness of the data sent from the SAN to the NAS, only the performance of the responses from the SAN to the NAS.

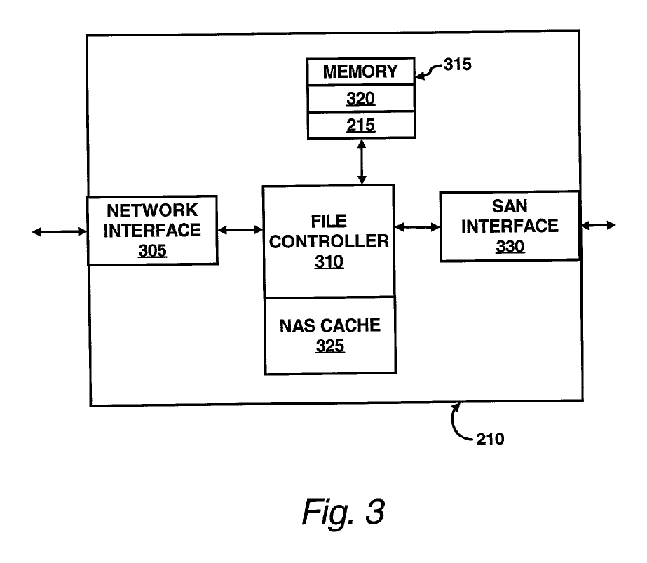

FIG. 3 illustrates an exemplary block diagram of the NAS 210 shown in FIG. 2 in accordance with the principles of the present invention. In particular, the NAS 210 includes a network interface 305 configured to interface the NAS 210 with the network 230. The network interface 305 is bidirectional, i.e., the network interface 305 is configured to receive and transmit data and/or commands between the NAS 210 and clients/application servers.

The network interface 305 of the NAS 210 may be further configured to interface with a file controller 310. The file controller 310 may be configured to execute appropriate protocols for the network file system 215 such as NFS, CIFS, etc. The file controller 310 may be further configured to interface with a memory 315. The memory 315 may be configured to provide storage for the code for the network file system 215 and data such as an available free block table 320.

The available free block table 320 may be configured to represent to the NAS 210 those blocks that are eligible for reuse by the NAS 210. When files and/or directories are deleted, the blocks released by the deletion are added to the available free block table 320. Conversely, when files and/or directories are created, the blocks used by the creation are taken off the available free block table 320.

A NAS cache 325 may interface with the file controller 310. The NAS cache 325 may be configured to provide temporary storage of files that are currently accessed by the clients 240. The NAS cache 325 may be implemented with high-speed dynamic random access memory (“RAM”), synchronous RAM or the like.

The file controller 310 may be further configured to interface with a SAN interface 330. The SAN interface 330 may be configured to provide a bi-directional communication channel between the NAS 210 and the SAN 220.

When a client 240 initiates a delete (or remove) command, the delete command specifying a file (or directory) to be deleted may be transmitted over the network 230 to the NAS 210 through the network interface 305. The network interface 305 may forward the delete command to the file controller 310. The file controller 310 may respond to the received delete command by deleting the specified file from the network file system 215 and updating the available free block table 320. The file controller 310 may determine if the NAS cache 325 contains a copy of the deleted file. If the NAS cache 325 contains a copy of the deleted file, the file controller 310 may flush the NAS cache 325 of the file. The file controller 310 may also generate a freed block message 250 as a form of optimization information specifying a list of the blocks that was freed when the file was deleted. The file controller 310 may further transmit the freed block message 250 through the SAN interface 330 to the SAN 220.

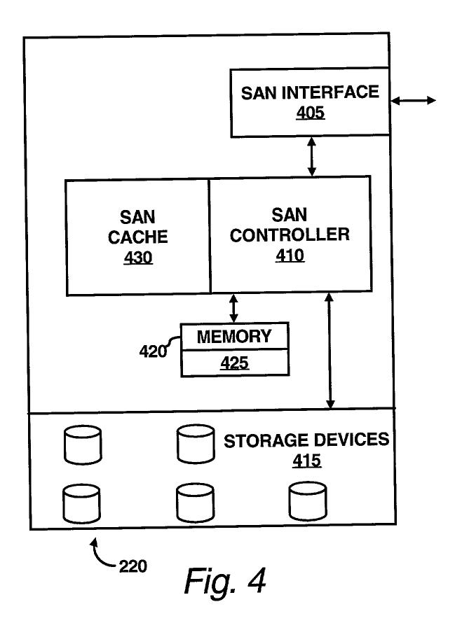

FIG. 4 illustrates an exemplary detailed block diagram of the SAN 220 shown in FIG. 2 in accordance with the principles of the present invention. In particular, the SAN 220 includes a SAN interface 405 configured to provide a bi-direction communication channel between the SAN 220 and a NAS 210 (or other host device). The SAN interface 405 may be further configured to interface with a SAN controller 410. The SAN controller 410 may be configured to provide the functionality of the SAN 220 by implementing a SCSI or other comparable protocol across storage devices 415.

The storage devices 415 are configured as a multi-tiered storage system. In particular, the physical storage of the storage devices 415 may be represented as two virtual storage spaces. The first virtual storage space is configured to represent the physical storage as a mirror, RAID level 1, area and a parity, RAID level 5, area thus creating the multi-tiered storage system. The second virtual storage space, an application-level storage space, is configured to present to clients/application servers the physical storage of the storage devices as multiple blocks, where a block may be associated with either the mirror RAID area or the virtual RAID area. The storage devices 415 may be implemented by disk drives, tape drives, etc.

A SAN memory 420 may be configured to interface with the SAN controller 410. The SAN memory 420 may be configured to store computer code for the functionality of the SAN 220 and/or data such as a current free block table 425.

The current free block table 425 may be configured to represent free blocks as designated by the NAS 210. The blocks represented or listed on the current free block table 425 may be configured to represent to the SAN 220 that the blocks are still allocated. As a result, the SAN 220 may not overwrite the blocks listed on the current free block table 425 until the NAS 210 overwrites the blocks. However, from the SAN 210 perspective, the blocks listed on the current free block table 425 may be designated as eligible for migration.

The SAN controller 410 may be further configured to interface with a SAN cache 430. The SAN cache 430 may be configured to provide temporary storage of blocks of data that are to be accessed by the NAS 210.

When the SAN interface 405 receives a freed block message 250 specifying a list of freed blocks, the SAN controller 410 may be configured to parse the freed block message 250 to identify the freed blocks. The identified freed blocks may subsequently be added to the current free block table 425. The SAN controller 410 may be further configured to either flush the freed blocks, mark as unused or mark as allocated but unused, the freed blocks from the SAN cache 430 depending on a status of the SAN 220.

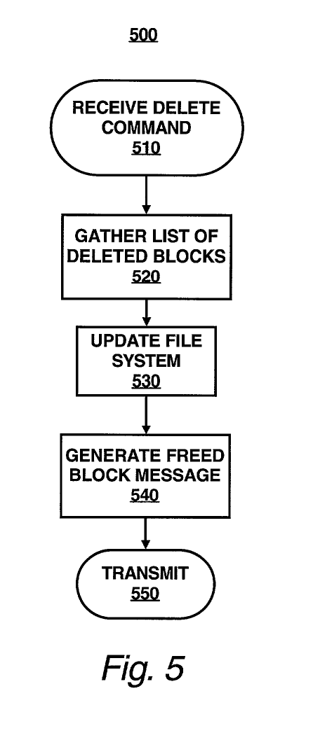

FIG. 5 is an exemplary flow diagram 500 of a generation of a freed block message in the NAS 210 shown in FIGS. 2 and 3. In particular, in step 510, the network interface 305 of the NAS 210 receives a delete command from a client 240. The network interface 305 may forward the delete command to the file controller 310.

In step 520, the file controller 310 may determine the file (or directory) to be deleted by parsing the received delete command. The file controller 310 may be further configured to delete the specified file and release the blocks associated with the deleted file.

In step 530, the file controller 310 may update the available free block table 320 with the released blocks of the deleted file. In step 540, the file controller 310 may be further configured to generate a freed block message 250 including the block(s) associated with the deleted file (or directory) as an “out-of-band” information from the conventional disk protocol.

In step 550, the file controller 310 may transmit the freed block message 250 to the SAN 220 through the SAN interface 330.

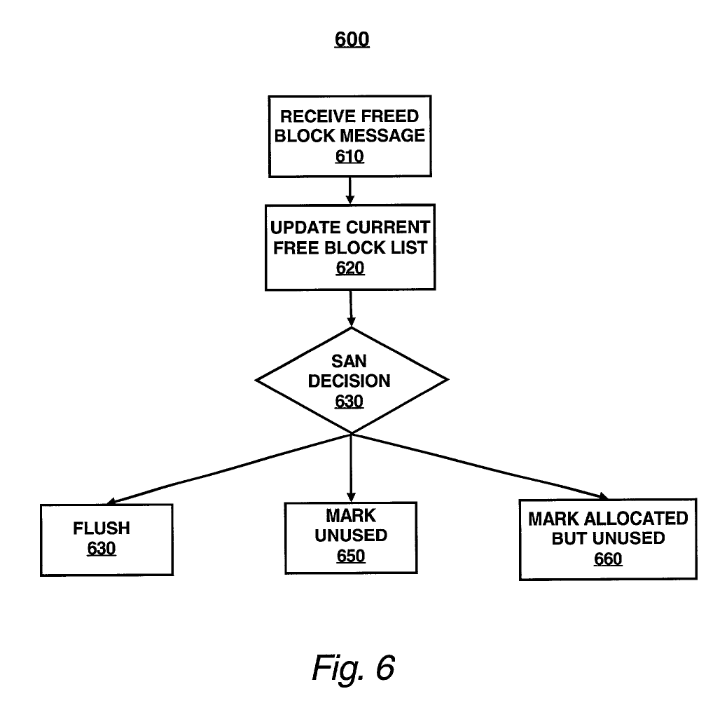

FIG. 6 illustrates an exemplary flow diagram 600 of processing a freed block message in the SAN 220 shown in FIGS. 2 and 4. In particular, in step 610, the SAN interface 405 of the SAN 220 may receive the freed block message 250 from the NAS 210. The SAN interface 405 may be configured to forward the freed block message 250 to the SAN controller 410 of the SAN 220.

In step 620, the SAN controller 410 may be configured to parse the freed block message 250 to update the current free block table 425. For example, the block enumerated in the freed block message 250 may be added to the list of blocks included in the current free block table 425 stored in the memory 420 of the SAN 220.

Once the free block table has been updated with the freed blocks from the freed block message 250, the SAN controller 410 may be configured to decide on a course of action for the blocks listed on the current free block table 425, in step 630.

Depending on various performance parameters such as disk input/output, throughput, etc, the SAN controller may mark all or a subset of the blocks listed on the current free block table 425 to be flushed. The SAN controller 425, in step 640 may mark all or a subset of the blocks listed on the current free block table 425 as unused. The SAN controller 425, in step 650 may mark all or a subset of the blocks listed on the current free block table 425 as allocated but unused any blocks in the free block table 425, in step 660.

The present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While the invention has been described with reference to the exemplary embodiment(s) thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents

What is claimed is:

1. A method for optimizing a storage system, the method comprising:
receiving an optimization information, said optimization information not included in a disk protocol of said data storage system; and
optimizing said data storage system according to said optimization information.

2. The method for optimizing a storage system according to claim 1, wherein said optimization information includes an enumeration of a plurality of blocks and said optimizing includes updating a current free block table with said plurality of blocks

3. The method for optimizing a storage system according to claim 2, further comprising:
generating said optimization information in response to a request for a deletion of a file; and
releasing said plurality of blocks associated with said deleted file.

4. The method for optimizing a storage system according to claim 3, further comprising:
updating an available free block table with said plurality of blocks associated with said deleted file.

5. The method for optimizing a storage system according to claim 4, wherein said storage system is configured to interface said file system controller with FIBRE channel.

6. The method for optimizing a storage system according to claim 5, wherein said file system controller communicates with said storage system utilizing a SCSI protocol.

7. The method for optimizing a storage system according to claim 2, further comprising:
generating said optimization information in response to a request for a deletion of a directory.

8. The method for optimizing a storage system according to claim 2, wherein said optimization information includes a freed block message.

9. A computer readable storage medium on which is embedded one or more computer programs, said one or more computer programs implementing a method of optimizing a storage system, said one or more computer programs comprising a set of instructions for:
receiving an optimization information, said optimization information not included in a disk protocol of said storage system; and
optimizing said storage system according to said optimization information.

10. The computer readable storage medium according to claim 8, said one or more computer programs further comprising a set of instructions wherein said optimization information includes an enumeration of a plurality of blocks and said optimizing includes updating a current free block table with said plurality of blocks.

11. The computer readable storage medium according to claim 10, said one or more computer programs further comprising a set of instructions for:
generating said optimization information in response to a request for a deletion of a file; and
releasing said plurality of blocks associated with said deleted file.

12. The computer readable storage medium according to claim 11, said one or more computer programs further comprising a set of instructions for:
updating an available current free block table with said plurality of blocks associated with said deleted file.

13. The computer readable storage medium according to claim 12, said one or more computer programs further comprising a set of instructions for:
generating said optimization information in response to a request for a deletion of a directory.

14. A system for optimizing storage, said system comprising:
a file system controller; and
a storage system, wherein said file system controller is configured to generate an optimization information, said optimization information being transmitted to said storage system and not included in a disk protocol of said storage system.

15. The system for optimizing storage according to claim 14, wherein said file controller is further configured to release a plurality of blocks associated with a deleted file in response to said deletion request and to enumerate said plurality of blocks in said optimization information.

16. The system for optimizing storage according to claim 15, wherein said file controller is further configured to update said plurality of blocks associated with a deleted file in an available free block table.

17. The system for optimizing storage according to claim 16, wherein said file controller is further configured to transmit said optimization information to said storage system.

18. The system for optimizing storage according to claim 18, wherein said storage system is configured to update a current free block table in response to receiving said optimization information.

19. The system for optimizing storage according to claim 18, wherein said storage system is further configured to flush at least one block listed on said current free block table.

20. The system for optimizing storage according to claim 18, wherein said storage system is further configured to mark as unused at least one block listed on said current free block table.

21. The system for optimizing storage according to claim 18, wherein said storage system is further configured to mark as allocated but unused at least one block listed on said current free block table.

22. The system for optimizing storage according to claim 14, wherein said file controller is further configured to release a plurality of blocks associated with a deleted directory in response to said deletion request and to enumerate said plurality of blocks in said optimization information.
